(19) United States
(12) Patent Application Publication
(10) Pub. No.: US 2025/0260117 A1
(43) Pub. Date: Aug. 14, 2025

(54) POWER STORAGE DEVICE

(71) Applicant: TOYOTA JIDOSHA KABUSHIKI KAISHA, Toyota-shi (JP)

(72) Inventor: Shinya GOITSUKA, Toyota-shi (JP)

(73) Assignee: TOYOTA JIDOSHA KABUSHIKI KAISHA, Toyota-shi (JP)

(21) Appl. No.: 18/977,121

(22) Filed: Dec. 11, 2024

(30) Foreign Application Priority Data
Feb. 8, 2024 (JP) 2024-018054

(51) Int. Cl. H01M 50/289; H01M 10/52; H01M 10/658; H01M 50/209; H01M 50/249; H01M 50/271

(52) U.S. Cl. CPC H01M 50/289; H01M 10/52; H01M 10/658; H01M 50/249; H01M 50/271; H01M 50/209

(57) ABSTRACT

A power storage device includes a plurality of power storage modules, a case that accommodates the plurality of power storage modules, and a coupling bracket disposed between two of the plurality of power storage modules, which are arranged in an X direction. The case includes an upper cover that covers the plurality of power storage modules from above. The coupling bracket includes an upper surface. The upper surface of the coupling bracket is in surface contact with the upper cover.

### CROSS REFERENCE TO RELATED APPLICATIONS

This nonprovisional application is based on Japanese Patent Application No. 2024-018054 filed on Feb. 8, 2024 with the Japan Patent Office, the entire contents of which are hereby incorporated by reference.

### BACKGROUND

### Field

The present disclosure relates to a power storage device.

### Description of the Background Art

Japanese Patent Laying-Open No. 2023-046977 discloses a battery pack structure including an upper case, a lower case, and a power storage module. The power storage module includes a plurality of secondary battery cells having smoke outlets and is accommodated inside a case (the upper case and the lower case).

### SUMMARY

A bracket may be disposed between power storage modules adjacent to each other, which is not described in Japanese Patent Laying-Open No. 2023-046977 mentioned above. In this case, it is assumable that debris caused by generation of smoke from a power storage module can be accumulated on the upper surface of the bracket and diffused to an adjacent power storage module. Accordingly, heat is conducted to the adjacent power storage module via the accumulated debris. This leads to generation of smoke in the adjacent power storage module as well and generation of smoke may occur in series in the power storage modules. In this case, the power storage modules adjacent to each other are brought into conduction via the smoke generated and a large-scale short circuit is caused in the power storage device.

The present disclosure has been made to solve the above-described problem and is aimed at providing a power storage device that, with a bracket disposed between power storage modules adjacent to each other, enables it to hinder conduction of heat between the power storage modules adjacent to each other.

A power storage device according to an aspect of the present disclosure includes a plurality of power storage modules, a case that accommodates the plurality of power storage modules, and a bracket disposed between two power storage modules of the plurality of power storage modules, the two power storage modules being arranged in a predetermined direction orthogonal to an up-and-down direction. The case includes an upper cover that covers the plurality of power storage modules from above. The bracket includes an upper surface. The upper surface of the bracket is in surface contact with the upper cover.

In the power storage device according to the aspect of the present disclosure, as described above, the upper surface of the bracket is in surface contact with the upper cover. Thus, it is enabled to hinder smoke generated from a power storage module from passing between the bracket and the upper cover. As a result, it is enabled to hinder accumulation of debris on the upper surface of the bracket and diffusion of the debris. Accordingly, conduction of heat between two power storage modules via debris can be hindered.

In the power storage device according to the aspect, preferably, the bracket includes a lower surface opposite to the upper surface. The lower surface of the bracket is positioned below an upper end surface of each of the two power storage modules. The foregoing configuration enables it to hinder passage of smoke under the lower surface of the bracket. As a result, conduction of heat between the two power storage modules due to smoke flowing between the two power storage modules can be hindered. Accordingly, generation of smoke can be hindered from occurring in series in the two adjacent power storage modules.

In the power storage device according to the aspect, preferably, the bracket includes a heat insulation material forming the upper surface. This configuration enables it to further hinder conduction of heat between two power storage modules, because of the heat insulation material, even when debris is slightly accumulated between the bracket and the upper cover.

In the power storage device according to the aspect, preferably, the upper cover includes a cover upper surface portion positioned so as to face the plurality of power storage modules in the up-and-down direction. The cover upper surface portion is provided with a bead portion extending along the upper surface of the bracket and formed so as to rise upward. The bead portion is in surface contact with the upper surface of the bracket. An object with a bead is higher in rigidity (flexural rigidity) than an object without any bead. Thus, the foregoing configuration enables it to hinder conduction of heat between the two power storage modules while the rigidity of the upper cover is enhanced. Further, by disposing the bracket so that the upper surface of the bracket is in surface contact of the bead portion rising upward, space for disposing the bracket under the upper cover can be easily reserved.

In this case, preferably, the case includes a lower case supporting the plurality of power storage modules from below and connected to the upper cover so that an accommodation space of the plurality of power storage modules is formed. The upper cover includes a connection portion connected to the lower case, and a coupling portion coupling the cover upper surface portion and the connection portion. At least one of the connection portion and the coupling portion is lower in rigidity than the cover upper surface portion. This configuration enables it to connect the upper cover and the lower case while the at least one of the connection portion and the coupling portion is deformed. As a result, the upper cover and the lower case can be connected easily.

In the power storage device according to the aspect, preferably, a laid material accommodated in the case is included. The case includes an inner side surface provided so as to surround the plurality of power storage modules when viewed from above. The laid material is disposed in a space between at least one of the plurality of power storage modules and the inner side surface. This configuration enables it to hinder smoke generated from a power storage module from flowing along the inner side surface of the case because of the laid material.

In the power storage device according to the aspect, preferably, each of the two power storage modules includes a side surface provided so as to face the bracket in the predetermined direction. In the predetermined direction, the bracket has a width substantially equal to a distance between the side surfaces of the two power storage modules. The foregoing configuration enables it to effectively hinder (block) passage of smoke over the bracket. The width of the bracket being substantially equal to the distance indicates that the bracket occupies most of the gap (space) between the side surfaces.

The foregoing and other objects, features, aspects, and advantages of the present disclosure will become apparent from the following detailed description of the present disclosure, which will be understood in conjunction with the accompanying drawings.

### BRIEF DESCRIPTION OF THE DRAWINGS

FIG. 1 is a plan view illustrating a configuration of a power storage device (a lower case and power storage modules) according to an embodiment.

FIG. 2 is a plan view illustrating a configuration of the power storage device (an upper cover) according to the embodiment.

FIG. 3 is a partial perspective view of FIG. 1 on an enlarged scale.

FIG. 4 is an exploded perspective view of the power storage module according to the embodiment.

FIG. 5 is a side view illustrating a configuration of a power storage cell according to the embodiment.

FIG. 6 is a partial perspective view on an enlarged scale, which illustrates a configuration of a coupling bracket and its vicinity according to the embodiment.

FIG. 7 is a cross sectional view along line VII-VII in FIG. 6.

FIG. 8 is a cross sectional view along line VIII-VIII in FIG. 6.

FIG. 9 is a cross sectional view along line IX-IX in FIG. 1.

FIG. 10 is a cross sectional view of a coupling bracket according to a variation of the embodiment.

### DESCRIPTION OF THE PREFERRED EMBODIMENTS

Embodiments of the present disclosure are described in detail below with reference to the drawings. In the drawings, the same or corresponding portions are denoted by the same reference characters, which will not be described repeatedly.

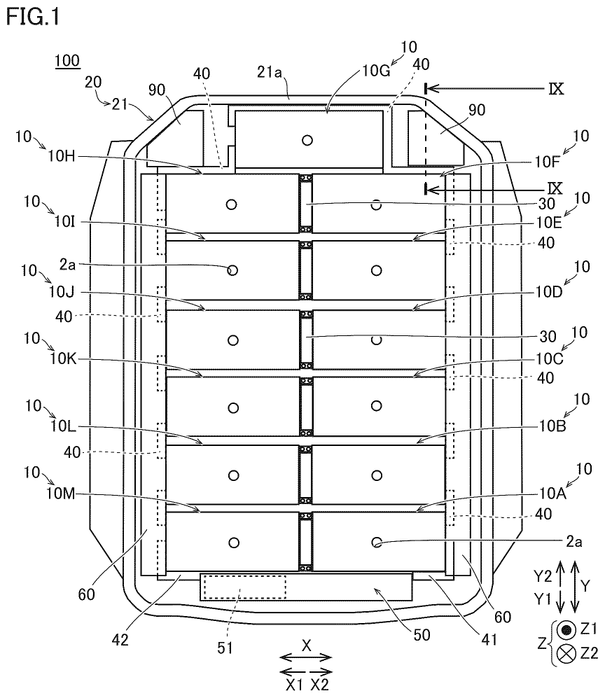

FIG. 1 is a plan view illustrating a power storage device 100 according to the present embodiment. Power storage device 100 stores power for driving an electrically powered vehicle (not illustrated), for example. Power storage device 100 includes a plurality of (in the present embodiment, thirteen) power storage modules 10, a case 20, and a plurality of (in the present embodiment, six) coupling brackets 30. The number of power storage modules 10 is not limited to this example. Coupling bracket 30 is an example of the “bracket” according to the present disclosure.

In power storage device 100, two power storage modules 10 are arranged in an X direction. Six sets of two power storage modules 10 arranged in the X direction are arranged in a Y direction. One of thirteen power storage modules 10 is arranged on the Y2 side of the endmost set in the Y2 direction among the six sets. The X direction is a direction orthogonal to an up-and-down direction (a Z direction) (i.e., the X direction is a direction along a horizontal surface). The Y direction is a direction orthogonal to each of the X direction and the Z direction. The Y direction is a forward and rearward direction of the electrically powered vehicle. For example, the Y1 side and the Y2 side correspond to the front side and the rear side, respectively. The X direction and the Z direction are respective examples of the “predetermined direction” and the “up-and-down direction” according to the present disclosure.

In FIG. 1, counterclockwise from the endmost power storage module 10 in the Y1 direction and also in the X2 direction, thirteen power storage modules 10 are respectively denoted as power storage modules 10A, 10B, 10C, 10D, 10E, 10F, 10G, 10H, 10I, 10J, 10K, 10L, and 10M. Thus, power storage modules 10A and 10M are adjacent to each other in the X direction. Power storage modules 10B and 10L are adjacent to each other in the X direction. Power storage modules 10C and 10K are adjacent to each other in the X direction. Power storage modules 10D and 10J are adjacent to each other in the X direction. Power storage modules 10E and 10I are adjacent to each other in the X direction. Power storage modules 10F and 10H are adjacent to each other in the X direction. Power storage module 10G is adjacent to each of power storage modules 10F and 10H in the Y direction while not adjacent to any other power storage module 10 in the X direction.

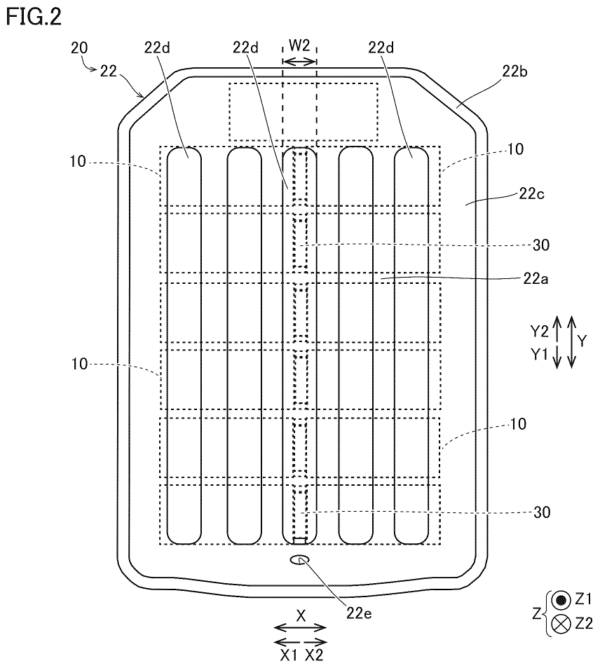

Case 20 accommodates the plurality of power storage modules 10. Case 20 includes a lower case 21 and an upper cover 22 (see FIG. 2). In FIG. 1, upper cover 22 is not illustrated for simplification.

Lower case 21 supports the plurality of power storage modules 10 from the Z2 side (from below). Upper cover 22 (see FIG. 2) covers the plurality of power storage modules 10 from the Z1 side (from above). Lower case 21 is connected to upper cover 22 so that an accommodation space of the plurality of power storage modules 10 is formed. Specifically, lower case 21 has a depressed shape depressed downward. Thus, lower case 21 and upper cover 22 are connected to each other and the above-mentioned accommodation space is formed accordingly.

Lower case 21 includes an edge portion 21a provided so as to surround the plurality of power storage modules 10 when viewed from the Z1 side. Edge portion 21a is connected to an edge portion 22b of upper cover 22, which is described later.

Each of the plurality of coupling brackets 30 is disposed between two power storage modules 10 arranged (adjacent to each other) in the X direction. Specifically, each of the plurality of coupling brackets 30 couples two power storage modules 10 arranged in the X direction. Thus, the distance between the two power storage modules can be made relatively small and power storage device 100 can be decreased in size. As a result, a crash stroke of power storage device 100 for a case of a collision of the electrically powered vehicle can be spared easily.

Power storage device 100 includes a busbar 40 that electrically connects power storage modules 10 arranged in the Y direction. Busbar 40 electrically connects power storage modules 10A and 10B. Busbar 40 electrically connects power storage modules 10B and 10C. Busbar 40 electrically connects power storage modules 10C and 10D. Busbar 40 electrically connects power storage modules 10D and 10E. Busbar 40 electrically connects power storage modules 10E and 10F. Busbar 40 electrically connects power storage modules 10F and 10G.

Busbar 40 electrically connects power storage modules 10G and 10H. Busbar 40 electrically connects power storage modules 10H and 10I. Busbar 40 electrically connects power storage modules 10I and 10J. Busbar 40 electrically connects power storage modules 10J and 10K. Busbar 40 electrically connects power storage modules 10K and 10L. Busbar 40 electrically connects power storage modules 10L and 10M.

Power storage device 100 includes a junction box 50 where wiring units in power storage device 100 are housed collectively. Further, power storage device 100 includes a busbar 41 that electrically connects junction box 50 and power storage module 10A. Further, power storage device 100 includes a busbar 42 that electrically connects junction box 50 and power storage module 10M.

Twelve busbars 40, busbar 41, and busbar 42 form a circuit with a path from junction box 50 via power storage modules 10A to 10M to junction box 50. That is, a high-voltage circuit is made by busbars 40 to 42 and junction box 50, running inside case 20.

Junction box 50 is provided with a fuse 51. Fuse 51 is blown as a result of large current flowing in the circuit. In this case, current stops flowing in the circuit. For example, when power storage module 10A and power storage module 10M with respective voltages that are largely different are brought into conduction by generation of smoke or the like, large current flows.

Power storage device 100 includes two protection covers 60. Protection cover 60 is provided so as to prevent a conductive foreign substance from adhering to busbar 40 (41, 42) when smoke is generated in power storage module 10. One of two protection covers 60 is provided on the X1 side so as to cover busbars 40 (41) arranged in the Y direction from the Z1 side. The other of two protection covers 60 is provided on the X2 side so as to cover busbars 40 (42) arranged in the Y direction from the Z1 side.

FIG. 2 is a plan view of upper cover 22 viewed from the Z1 side. Upper cover 22 includes a cover upper surface portion 22a, edge portion 22b, and a coupling portion 22c. Cover upper surface portion 22a is positioned so as to face the plurality of power storage modules 10 in the Z direction. In other words, cover upper surface portion 22a is provided so as to cover the region where the plurality of power storage modules 10 are arranged from the Z1 side. Edge portion 22b forms an outer edge of upper cover 22. By edge portion 22b being connected to edge portion 21a (see FIG. 1) of lower case 21, upper cover 22 is attached to lower case 21. Coupling portion 22c couples cover upper surface portion 22a and edge portion 22b. When viewed from the Z1 side, coupling portion 22c is provided so as to surround cover upper surface portion 22a. That is, coupling portion 22c is formed so as to have a ring-like shape. Edge portion 22b is an example of the “connection portion” according to the present disclosure.

On cover upper surface portion 22a, a plurality of (in the present embodiment, five) bead portions 22d are formed. Each of the plurality of bead portions 22d is formed so as to rise toward the Z1 side. Each of the plurality of bead portions 22d extends along the Y direction. The plurality of bead portions 22d are arranged in the X direction. One of the plurality of bead portions 22d (in FIG. 2, bead portion 22d in the center) extends along an upper surface 33a of coupling bracket 30, which is described later. Bead portion 22d in the center is arranged so as to cover six coupling brackets 30 arranged in the Y direction from the Z1 side. Among five bead portions 22d, bead portions 22d other than bead portion 22d in the center are not necessarily required to be provided on upper cover 22 (cover upper surface portion 22a). In addition, the number of bead portions 22d is not limited to the above-described example.

Upper cover 22 is provided with a pressure release valve 22e. When pressure in case 20 becomes higher than or equal to a threshold value owing to gas (including smoke) generated from the plurality of power storage modules 10, pressure release valve 22e discharges the gas to the outside of case 20. Pressure release valve 22e is provided on the Y1 side of the endmost coupling bracket 30 in the Y1 direction among six coupling brackets 30 arranged in the Y direction. The position of pressure release valve 22e is not limited to the above-described example.

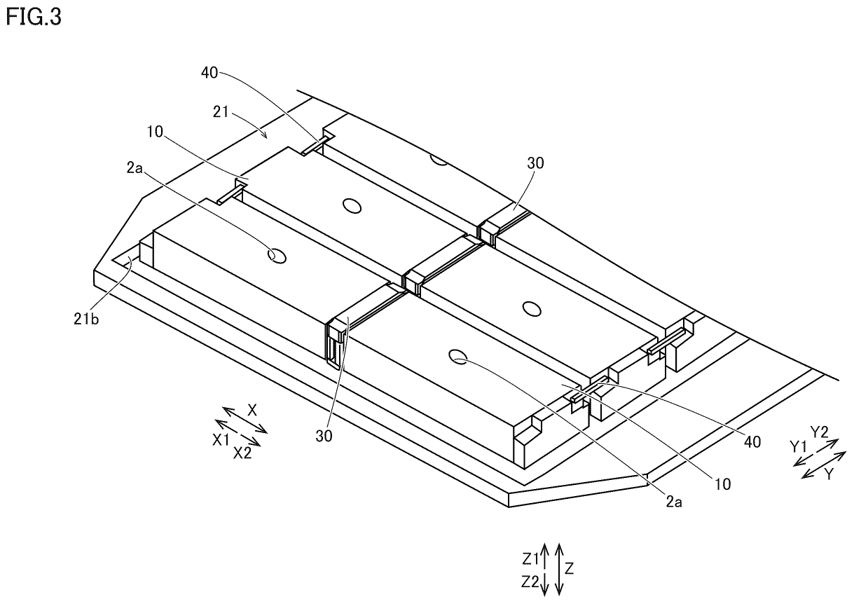

FIG. 3 is a partial perspective view on an enlarged scale, which illustrates part of the plurality of power storage modules 10. In FIG. 3, junction box 50, busbar 41, busbar 42, protection cover 60, and the like are not illustrated for simplification.

Lower case 21 includes an inner side surface 21b provided so as to surround the plurality of power storage modules 10 when viewed from the Z1 side. Inner side surface 21b is positioned so as to face the plurality of power storage modules 10. Inner side surface 21b is an example of the “inner side surface” according to the present disclosure.

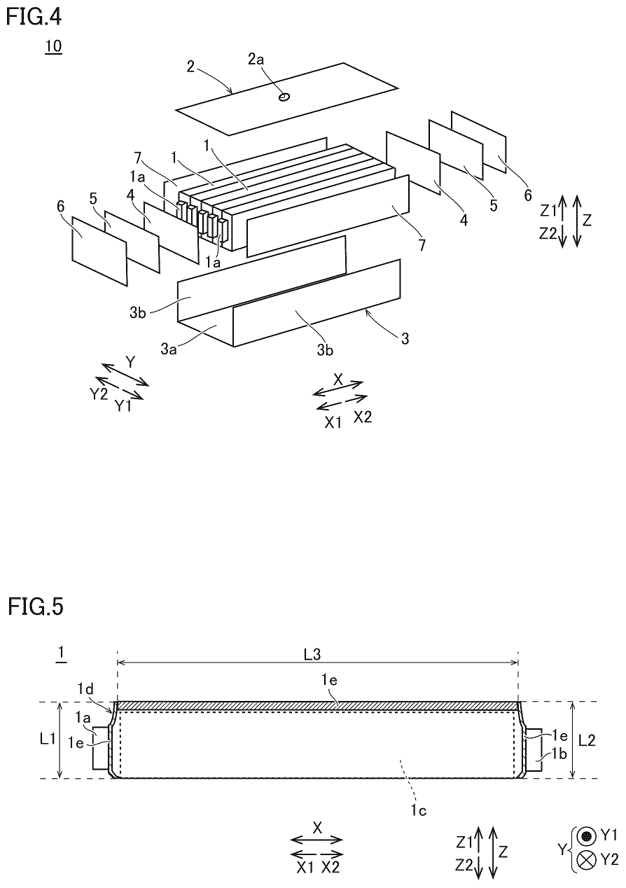

FIG. 4 is an exploded perspective view of power storage module 10. Power storage module 10 includes a plurality of power storage cells 1, an upper plate 2, a lower frame 3, a pair of busbar frame units 4, a pair of electrical insulation covers 5, a pair of end plates 6, and a pair of compression pads 7.

Each of the plurality of power storage cells 1 is formed so as to extend in the X direction. Each of the plurality of power storage cells 1 has a shape of a prism (a shape of a rectangular prism). The plurality of power storage cells 1 are arranged in the Y direction. An end portion of each of the plurality of power storage cells 1 on the X1 side is provided with an electrode terminal 1a (for example, a positive electrode terminal). An end portion of each of the plurality of power storage cells 1 on the X2 side is provided with an electrode terminal 1b (see FIG. 5) (for example, a negative electrode terminal).

Upper plate 2 is disposed so as to cover (close) the plurality of power storage cells 1 from the Z1 side. Upper plate 2 is provided with a gas discharge hole 2a. Gas generated from power storage cell 1 is discharged through gas discharge hole 2a.

Lower frame 3 includes a bottom plate 3a and a pair of side plates 3b. The pair of side plates 3b are provided so as to extend from respective end portions of bottom plate 3a on the Y1 side and the Y2 side to the Z1 side. Bottom plate 3a supports the plurality of power storage cells 1 from the Z2 side. The pair of side plates 3b are provided so that the plurality of power storage cells 1 are sandwiched therebetween in the Y direction.

Each of the pair of busbar frame units 4 is disposed along the plurality of power storage cells 1 so as to fix (hold) busbar 40 (41, 42) attached to power storage module 10. The pair of busbar frame units 4 are respectively disposed on the X1 side and the X2 side of the plurality of power storage cells 1.

One of the pair of electrical insulation covers 5 is provided so as to cover busbar frame unit 4 on the X1 side from the X1 side. The other of the pair of electrical insulation covers 5 is provided so as to cover busbar frame unit 4 on the X2 side from the X2 side.

One of the pair of end plates 6 is provided so as to cover electrical insulation cover 5 on the X1 side from the X1 side. The other of the pair of end plates 6 is provided so as to cover electrical insulation cover 5 on the X2 side from the X2 side.

One of the pair of compression pads 7 is disposed so as to be sandwiched between power storage cell 1 and side plate 3b on the Y1 side. The other of the pair of compression pads 7 is disposed so as to be sandwiched between power storage cell 1 and side plate 3b on the Y2 side. The pair of compression pads 7 compress the plurality of power storage cells 1 in the Y direction.

FIG. 5 is a side view of power storage cell 1 viewed from a side. Power storage cell 1 includes a cell body portion 1c and a laminate film 1d. Cell body portion 1c is wrapped in laminate film 1d. Laminate film 1d includes a welded portion 1e (the shaded portion in FIG. 5) formed by welding edge portions of laminate film 1d together. Welded portion 1e is formed in respective end portions of laminate film 1d on the X1 side, the X2 side, and the Z1 side.

Welded portion 1e on the X1 side is formed so as to extend along the Z direction and has a length L1 in the Z direction. Welded portion 1e on the X2 side is formed so as to extend along the Z direction and has a length L2 in the Z direction. Welded portion 1e on the Z1 side is formed so as to extend along the X direction and has a length L3 in the X direction. Length L3 is larger than (for example, five or more times as large as) each of length L1 and length L2.

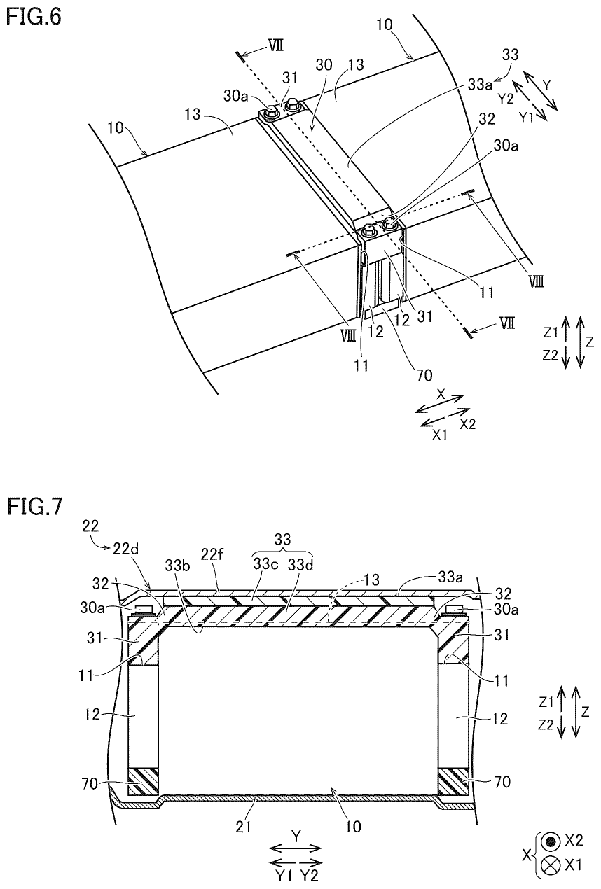

FIG. 6 is a partial perspective view of coupling bracket 30 and its vicinity on an enlarged scale. Power storage device 100 includes a plurality of bolts 30a and a plurality of fixing jigs 70. Coupling bracket 30 includes a pair of end portions 31, a pair of sloping portions 32, and a flat portion 33. The pair of end portions 31 are provided on respective end portions of coupling bracket 30 on the Y1 side and the Y2 side. Fixing jig 70 is disposed on the Z2 side of (under) each of the pair of end portions 31 of coupling bracket 30.

Power storage module 10 is provided with a pair of cut portions 11. In power storage module 10, each of the pair of cut portions 11 is provided in a corner portion that is on the Z1 side and on the coupling bracket 30 side. Power storage module 10 includes a pair of portions 12. One and the other of the pair of portions 12 are disposed on the respective Z2 sides of one and the other of the pair of cut portions 11. End portion 31 of coupling bracket 30 is supported from the Z2 side by respective portions 12 of two power storage modules 10 arranged in the X direction.

Two bolts 30a are used for each of end portions 31 of coupling bracket 30. Each of these two bolts 30a is inserted in fixing jig 70 through end portion 31 of coupling bracket 30 and portion 12 of power storage module 10. Thus, coupling bracket 30 and power storage module 10 are fastened together.

Two bolts 30a corresponding to each end portion 31 are arranged in the X direction. Bolt 30a of two bolts 30a arranged in the X direction that is on the X1 side couples (fastens) power storage module 10 of two power storage modules 10 arranged in the X direction that is on the X1 side and coupling bracket 30 together. Bolt 30a of two bolts 30a arranged in the X direction that is on the X2 side couples (fastens) power storage module 10 of two power storage modules 10 arranged in the X direction that is on the X2 side and coupling bracket 30 together.

One of the pair of sloping portions 32 is connected to end portion 31 on the Y1 side. The other of the pair of sloping portions 32 is connected to end portion 31 on the Y2 side. Each of the pair of sloping portions 32 is provided so as to extend from end portion 31 toward the Z1 side. Each of the pair of sloping portions 32 slopes so as to intersect each of the Z direction and the Y direction.

Flat portion 33 is situated between the pair of sloping portions 32. Flat portion 33 connects the pair of sloping portions 32. Flat portion 33 is provided on the Z1 side in relation to each of the pair of end portions 31. Flat portion 33 is formed like a flat surface extending so as to be orthogonal to the Z direction. When viewed from the Z1 side, flat portion 33 has a shape of a rectangle with a shorter side extending in the X direction and a longer side extending in the Y direction.

Flat portion 33 includes an upper surface 33a on the Z1 side and a lower surface 33b on the Z2 side (see FIG. 7). That is, lower surface 33b is provided so as to be opposite to upper surface 33a.

In the case of a conventional power storage device, it is assumable that debris caused by generation of smoke from a power storage module can be accumulated on an upper surface of a coupling bracket and diffused to an adjacent power storage module. Accordingly, heat is conducted to the adjacent power storage module via the accumulated debris. This leads to generation of smoke in the adjacent power storage module as well and generation of smoke may occur in series in the power storage modules. In this case, the power storage modules adjacent to each other are brought into conduction via the smoke generated and a large-scale short circuit is caused in the power storage device.

In the present embodiment, as illustrated in FIG. 7, upper surface 33a of coupling bracket 30 (flat portion 33) is in surface contact with upper cover 22. Specifically, upper surface 33a is entirely in (intimate) contact with upper cover 22. That is, coupling bracket 30 is disposed so that no gap is formed between upper surface 33a and upper cover 22.

In addition, in the present embodiment, lower surface 33b of coupling bracket 30 (flat portion 33) is positioned on the Z2 side (below) in relation to an upper end surface 13 of each of two power storage modules 10.

The foregoing configuration enables it to hinder (block) smoke discharged from gas discharge hole 2a (see FIG. 3) provided in upper end surface 13 of power storage module 10 from passing over coupling bracket 30 (flat portion 33). Thus, accumulation of debris on upper surface 33a of flat portion 33 can be hindered. In addition, passage of smoke under lower surface 33b of flat portion 33 can be hindered.

More specifically, upper surface 33a of coupling bracket 30 (flat portion 33) is in surface contact with bead portion 22d of upper cover 22. The end portion of bead portion 22d on the Z1 side is provided with a flat portion 22f. Flat portion 22f extends so as to be orthogonal to the Z direction. Upper surface 33a of coupling bracket 30 is in surface contact with flat portion 22f of bead portion 22d.

Further, coupling bracket 30 includes a heat insulation material 33c forming upper surface 33a. Specifically, flat portion 33 is constituted of heat insulation material 33c and a resin portion 33d. Heat insulation material 33c is formed like a sheet. Heat insulation material 33c is fixed (bonded) to a surface of resin portion 33d on the Z1 side. Heat insulation material 33c like a sheet is in surface contact with upper cover 22.

The pair of end portions 31 and the pair of sloping portions 32 of coupling bracket 30 are each formed of resin similarly to resin portion 33d. Resin portion 33d may be formed integrally with the pair of sloping portions 32 and the pair of end portions 31.

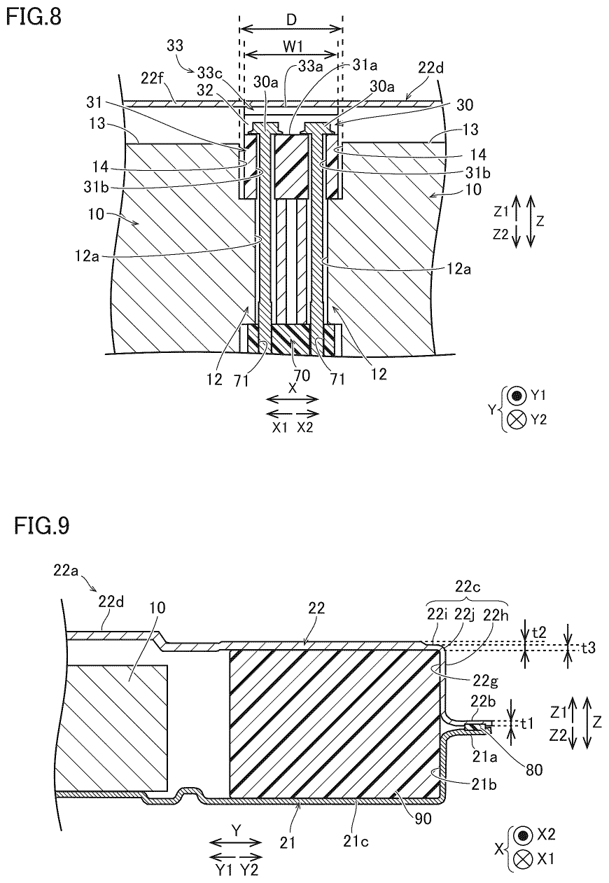

FIG. 8 is a cross sectional view along line VIII-VIII in FIG. 6. As illustrated in FIG. 8, upper end surface 31a of end portion 31 of coupling bracket 30 is positioned on the Z1 side in relation to upper end surface 13 of power storage module 10.

Two through holes 31b in which bolts 30a are inserted are provided in end portion 31 of coupling bracket 30. A through hole 12a in which bolt 30a is inserted is provided in portion 12 of power storage module 10. Two insertion holes 71 in which bolts 30a are inserted are provided in fixing jig 70. Bolt 30a is inserted in insertion hole 71 through through hole 31b and through hole 12a. Insertion hole 71 may be a through hole.

A width W1 of coupling bracket 30 (flat portion 33) in the X direction is smaller than a width W2 (see FIG. 2) of bead portion 22d in the X direction. More specifically, width W1 of coupling bracket 30 is smaller than a width (not given a reference character) of flat portion 22f of bead portion 22d in the X direction.

Each of the plurality of power storage modules 10 includes a side surface 14 provided so as to face coupling bracket 30 in the X direction. Respective side surfaces 14 of two power storage modules 10 arranged in the X direction are situated away from each other by a distance D. Width W1 of coupling bracket 30 in the X direction is substantially equal to distance D between side surfaces 14. Coupling bracket 30 occupies most of the space between side surfaces 14. For example, width W1 equals 95% or more of distance D. Width W1 may be completely equal to distance D. In this case, respective side surfaces 14 of two power storage modules 10 are in contact with coupling bracket 30.

FIG. 9 is a cross sectional view along line IX-IX in FIG. 1. Power storage device 100 includes a laid material 90 accommodated in case 20. In case 20, two laid materials 90 (see FIG. 1) are accommodated. Laid material 90 is formed of a foamed material for example.

Each of two laid materials 90 is disposed in a space between power storage module 10 and the inner side surface of case 20. The inner side surface of case 20 is constituted of inner side surface 21b of lower case 21 and an inner side surface 22g of upper cover 22. One of two laid materials 90 is disposed in the space between the inner side surface (21b, 22g) of case 20 and each of power storage modules 10F and 10G (see FIG. 1). The other of two laid materials 90 is disposed in the space between the inner side surface (21b, 22g) of case 20 and each of power storage modules 10G and 10H (see FIG. 1). Each of two laid materials 90 is in contact with both inner side surface 21b of lower case 21 and inner side surface 22g of upper cover 22. Inner side surface 22g is an example of the “inner side surface” according to the present disclosure.

Each of two laid materials 90 is provided so as to be sandwiched between (compressed by) upper cover 22 (cover upper surface portion 22a) and a bottom surface portion 21c of lower case 21 in the Z direction.

In the present embodiment, edge portion 22b of upper cover 22, which is connected to lower case 21, is lower in rigidity than cover upper surface portion 22a. In other words, edge portion 22b becomes deformed more easily than cover upper surface portion 22a. Specifically, a thickness t1 (a thickness in the Z direction) of edge portion 22b is smaller than a thickness t2 (a thickness in the Z direction) of cover upper surface portion 22a.

Further, as illustrated in FIG. 9, coupling portion 22c includes a first portion 22h extending along the Z direction, a second portion 22i extending along a horizontal direction, and a connection portion 22j. Connection portion 22j connects first portion 22h and second portion 22i. Connection portion 22j is bent.

In the present embodiment, coupling portion 22c is lower in rigidity than cover upper surface portion 22a. In other words, coupling portion 22c becomes deformed more easily than cover upper surface portion 22a. Specifically, a thickness t3 of coupling portion 22c is smaller than thickness t2 of cover upper surface portion 22a. In FIG. 9, the thickness of second portion 22i of coupling portion 22c is illustrated as thickness t2 of coupling portion 22c. The thickness of each of first portion 22h and connection portion 22j is equal to the thickness of second portion 22i. Only one or two of first portion 22h, second portion 22i, and connection portion 22j may have thickness t3 smaller than thickness t2 of cover upper surface portion 22a.

Power storage device 100 includes a seal member 80. A connection portion between edge portion 21a of lower case 21 and edge portion 22b of upper cover 22 is sealed with seal member 80. Seal member 80 has a shape of a flange (a shape of a ring). Seal member 80 is formed of resin, such as rubber.

As described above, in the present embodiment, upper surface 33a of coupling bracket 30 is in surface contact with upper cover 22. Thus, it is enabled to hinder smoke discharged from power storage module 10 from passing over coupling bracket 30. Accordingly, diffusion of debris between power storage modules 10 arranged in the X direction can be hindered. As a result, conduction of heat between power storage modules 10 can be hindered and generation of smoke can be hindered from occurring in series among power storage modules 10.

In addition, in the present embodiment, lower surface 33b of coupling bracket 30 is positioned below upper end surface 13 of power storage module 10. Thus, it is enabled to hinder smoke discharged from gas discharge hole 2a provided in upper end surface 13 of power storage module 10 from passing under coupling bracket 30. Accordingly, conduction of heat between two power storage modules 10 caused by passage of smoke between two power storage modules 10 can be hindered. Moreover, since accumulation (adhesion) of debris under coupling bracket 30 can be hindered, conduction of heat between two power storage modules 10 can be further hindered.

Moreover, in the present embodiment, coupling bracket 30 includes heat insulation material 33c forming upper surface 33a. Thus, conduction of heat between two power storage modules 10 via coupling bracket 30 can be hindered by heat insulation material 33c.

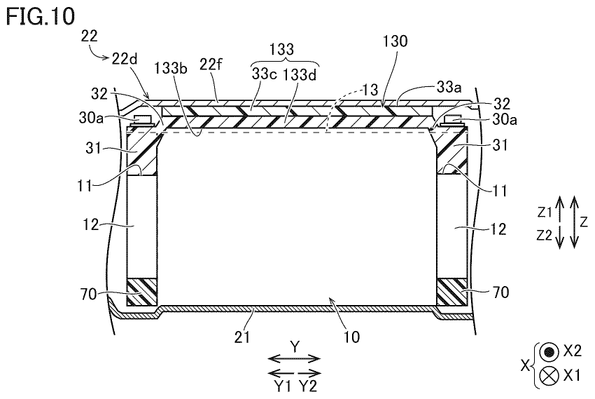

Although the present embodiment shows an example in which lower surface 33b of coupling bracket 30 is positioned below upper end surface 13 of power storage module 10, the present disclosure is not limited to this example. The lower surface of the coupling bracket may be positioned above upper end surface 13 of power storage module 10. For example, as illustrated in FIG. 10, a lower surface 133b of a coupling bracket 130 (a resin portion 133d of a flat portion 133) is positioned on the Z1 side (above) in relation to upper end surface 13. Coupling bracket 130 is an example of the “bracket” according to the present disclosure.

Although the present embodiment shows an example in which coupling bracket 30 couples two power storage modules 10, the present disclosure is not limited to this example. A bracket not coupled to each power storage module 10 may just be disposed between two power storage modules 10.

Although the present embodiment shows an example in which two power storage modules 10 are arranged in the X direction, the present disclosure is not limited to this example. Three or more power storage modules 10 may be arranged in the X direction.

Although the present embodiment shows an example in which upper surface 33a of coupling bracket 30 is formed by heat insulation material 33c, the present disclosure is not limited to this example. For example, coupling bracket 30 is not necessarily required to be provided with heat insulation material 33c. Instead of heat insulation material 33c, an adhesive material may be provided.

Although the present embodiment shows an example in which bead portion 22d of upper cover 22 is in surface contact with upper surface 33a of coupling bracket 30, the present disclosure is not limited to this example. Upper surface 33a of coupling bracket 30 may be in surface contact with a portion of cover upper surface portion 22a, where bead portion 22d is not formed.

Although the present embodiment shows an example in which thickness t1 of edge portion 22b of upper cover 22 is smaller than thickness t2 of cover upper surface portion 22a and accordingly, edge portion 22b is lower in rigidity than cover upper surface portion 22a, the present disclosure is not limited to this example. The material of which edge portion 22b of upper cover 22 is formed may be lower in rigidity than the material of which cover upper surface portion 22a is formed. Similarly, the material of which coupling portion 22c of upper cover 22 is formed may be lower in rigidity than the material of which cover upper surface portion 22a is formed. The rigidity of upper cover 22 may be uniform regardless of the position. Further, only one of edge portion 22b and coupling portion 22c may be lower in rigidity than cover upper surface portion 22a.

Although the present embodiment shows an example in which gas discharge hole 2a is provided in upper end surface 13 of power storage module 10, the present disclosure is not limited to this example. For example, a gas discharge hole may be provided in a side surface or a bottom surface of power storage module 10.

Although the present embodiment shows an example in which laid material 90 is accommodated in case 20, the present disclosure is not limited to this example. Laid material 90 is not necessarily required to be accommodated in case 20. Instead of laid material 90, another member (for example, a smoke absorption material or the like) may be provided.

Although the present embodiment shows an example in which width W1 of coupling bracket 30 in the X direction is substantially equal to distance D between respective side surfaces 14 of power storage modules 10, the present disclosure is not limited to this example. Width W1 may be smaller than (for example, 80% or less of) distance D.

Although embodiments of the present disclosure have been described, it should be understood that the herein-disclosed embodiments are presented by way of illustration and example in all respects and are not to be taken by way of limitation. The scope of the present disclosure is defined by the claims and intended to include any modifications within the purport and scope equivalent to the claims.

What is claimed is:

1. A power storage device comprising:
a plurality of power storage modules;
a case that accommodates the plurality of power storage modules; and
a bracket disposed between two power storage modules of the plurality of power storage modules, the two power storage modules being arranged in a predetermined direction orthogonal to an up-and-down direction, wherein
the case includes an upper cover that covers the plurality of power storage modules from above,
the bracket includes an upper surface, and
the upper surface of the bracket is in surface contact with the upper cover.

2. The power storage device according to claim 1, wherein
the bracket includes a lower surface opposite to the upper surface, and
the lower surface of the bracket is positioned below an upper end surface of each of the two power storage modules.

3. The power storage device according to claim 1, wherein the bracket includes a heat insulation material forming the upper surface.

4. The power storage device according to claim 1, wherein
the upper cover includes a cover upper surface portion positioned so as to face the plurality of power storage modules in the up-and-down direction,
the cover upper surface portion is provided with a bead portion extending along the upper surface of the bracket and formed so as to rise upward, and
the bead portion is in surface contact with the upper surface of the bracket.

5. The power storage device according to claim 4, wherein
the case includes a lower case supporting the plurality of power storage modules from below and connected to the upper cover so that an accommodation space of the plurality of power storage modules is formed,
the upper cover includes a connection portion connected to the lower case, and a coupling portion coupling the cover upper surface portion and the connection portion, and
at least one of the connection portion and the coupling portion is lower in rigidity than the cover upper surface portion.

6. The power storage device according to claim 1, further comprising
a laid material accommodated in the case, wherein
the case includes an inner side surface provided so as to surround the plurality of power storage modules when viewed from above, and
the laid material is disposed in a space between at least one of the plurality of power storage modules and the inner side surface.

7. The power storage device according to claim 1, wherein
each of the two power storage modules includes a side surface provided so as to face the bracket in the predetermined direction, and
in the predetermined direction, the bracket has a width substantially equal to a distance between the side surfaces of the two power storage modules.
